(19) United States
(12) Patent Application Publication
(10) Pub. No.: US 2012/0027512 A1
(43) Pub. Date: Feb. 2, 2012

(54) LOCK

(76) Inventor: Sean Evans, Burleigh Heads (AU)

(21) Appl. No.: 13/191,753

(22) Filed: Jul. 27, 2011

(30) Foreign Application Priority Data
Jul. 28, 2010 (AU) 2010100802

(51) Int. Cl. F16B 1/00

(52) U.S. Cl. 403/404

(57) ABSTRACT

A lock for retaining one or more ladders or trestles to a rack comprises a hook which hooks under the rack while the shaft of the hook extends through and beyond the one or more ladders or trestles and a cross beam with a flange at each end which receives the shaft of the hook and sits on and around the one or more ladders or trestles and a handle which also receives the shaft of the hook and secures the cross beam in place thereby fastening the one or more ladders or trestles to the rack and wherein said cross beam is extendable to fit a variety of ladder or trestle sizes.

### CROSS-REFERENCE TO RELATED APPLICATIONS

Pursuant to 35 U.S.C. §119 (a), this application claims the benefit of earlier filing date and right of priority to Australian Patent Application No. 2010100802, filed on Jul. 28, 2010, the contents of which is hereby incorporated by reference in its entirety.

### FIELD OF THE INVENTION

This invention relates to retaining ladders and trestles on the roof racks of vehicles and in particular to locking devices for achieving this.

### BACKGROUND OF THE DISCLOSURE

Ladders and trestles are an essential and costly tool in many industries including the construction, painting, window cleaning and roofing industries to name a few. Safely transporting ladders and trestles between locations has been a problem in these industries for many years.

Many have used straps or ties such as bungee cords, hockey straps, rope, cables, wires and the like to secure their ladders or trestles to their vehicles. However, these methods take significant time to secure and release the ladder or trestle each time. Furthermore, straps and ties are easily cut and to prevent theft the owner must store their ladder at the end of every day.

In an attempt to overcome these difficulties there have been a number of clamps or locks used to secure ladders to vehicles for safe transport and storage. One such clamp secures a ladder to the roof racks of a vehicle by means of a cross beam with flanges that rests on top of the ladder and a hook that hooks under the roof rack and inserts through the cross beam and is secured with a spinner nut and padlock on top of the cross beam effectively securing the ladder between the roof rack and the cross beam. Typically two of these clamps would be used, one for each of the two roof racks on a vehicle to ensure the ladder does not move during transport. This not only prevents the ladder from falling off the vehicle during braking, swerving and the like but also prevents theft of the ladder if unattended.

This type of clamp can only fit around certain ladder sizes and accordingly there are a number of sizes of the clamp available to fit different ladders. This is disadvantageous as a tradesman would need to have several different sized clamps which he would use for his different ladders or trestles. The spinner nut is also time consuming to remove each time. Further, the threaded hook which travels through the centre of the cross beam of the clamp is straight and therefore aligns with the edge of the roof rack which results in rotation of the entire lock when tightened onto the roof rack.

It is therefore an object of the present invention to overcome the disadvantageous of the prior art or at least to provide an alternative to the prior art.

### SUMMARY OF THE DISCLOSURE

According to the present invention a lock for fastening one or more ladders or trestles to a rack comprising a hook which hooks under the rack while the shaft of the hook extends through and beyond the one or more ladders or trestles and a cross beam with a flange at each end which receives the shaft of the hook and sits on and around the one or more ladders or trestles and a handle which also receives the shaft of the hook and secures the cross beam in place thereby fastening the one or more ladders or trestles to the rack and wherein said cross beam is extendable to fit a variety of ladder or trestle sizes.

Preferably, the extendable cross beam has a first and second member, the first member being hollow with a flange at one end and the other end being open to receive the second member, the second member having a flange at its other end.

Preferably, the first and second members of the extendable cross beam have a number of holes along two opposing sides which can be aligned such that the shaft of the hook can pass through the first and second members preventing movement of the members relative to each other thereby fixing the length of the cross beam.

Preferably, the hook shaft is threaded and the handle has a mating threaded hole such that the handle can be wound to either secure or release the cross beam from the one or more ladders or trestles and wherein the handle has a quick release mechanism comprising a hinged portion which can be moved to disengage the thread of the handle and the hook shaft to allow the handle to be taken off without the need to wind the handle off.

Preferably, the shaft of the hook is offset.

### BRIEF DESCRIPTION OF THE DRAWINGS

An embodiment of the invention is now described by way of example only with reference to the accompanying drawings in which:

FIG. 1 is a front elevation of the lock in situ securing a ladder onto a roof rack of a vehicle;

FIG. 2 is a side elevation of the lock in situ securing a ladder onto a roof rack of a vehicle;

FIG. 3 is a perspective view of the lock in situ securing a ladder onto a roof rack and shows how the lock is fastened into position;

FIG. 4 is a perspective view of the handle of the lock and shows the quick release mechanism;

FIG. 5 is a side elevation of the handle of the lock and shows the quick release mechanism in the secured position; and

FIG. 6 is a side elevation of the handle of the lock and shows the quick release mechanism in the released position.

### DETAILED DESCRIPTION

The present invention provides a device for securing one or more ladders or trestles to the racks on a vehicle for transport and storage of the ladders or trestles. Roof racks on a car or truck run horizontally from either side of the vehicle and are generally found in pairs.

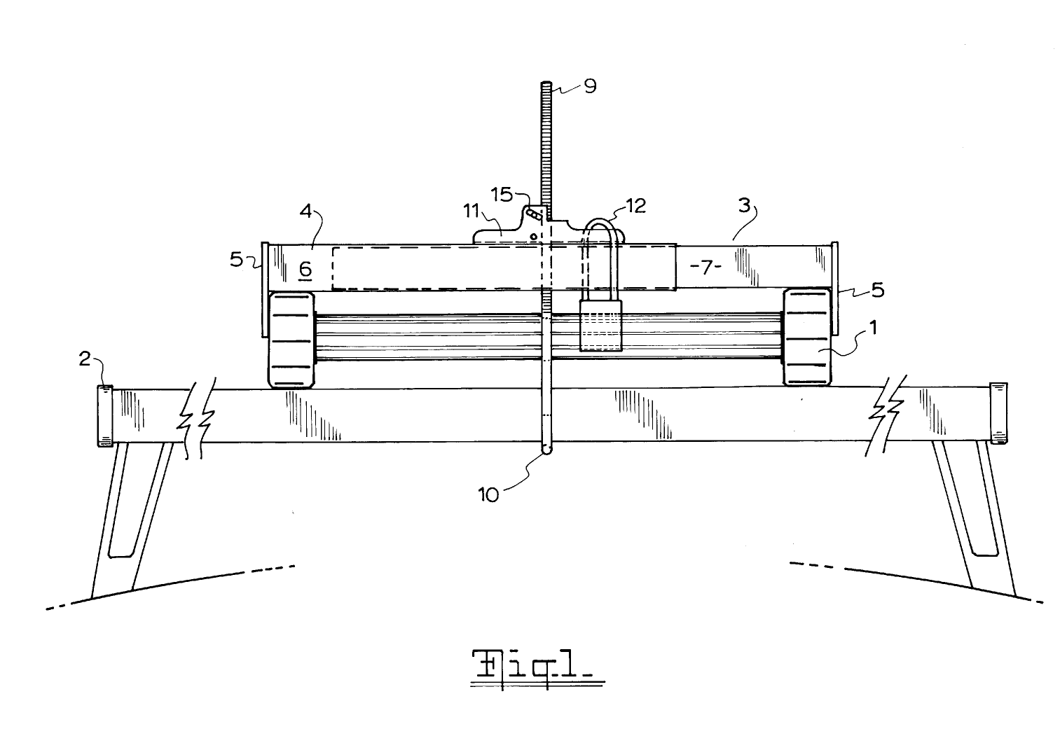

FIG. 1 shows ladder 1 on top of roof rack 2 of a vehicle secured by lock 3 of the present invention. Lock 3 comprises cross beam 4 with flanges 5 at either end which rests on top of ladder 1. Cross beam 4 can be one single piece (not shown) that fits a particular ladder or trestle size or it can be extendable to fit any width of ladder or trestle.

The extendable cross beam 4 comprises first member 6 and second member 7, first member 6 being a hollow steel section with an open end and a steel flange 5 welded on the other end. The open end of first member 6 receives an end of second member 7.

Second member 7 is also a steel section that has a slightly smaller cross section than first member 6. A steel flange 5 is also welded to the other end of second member 7.

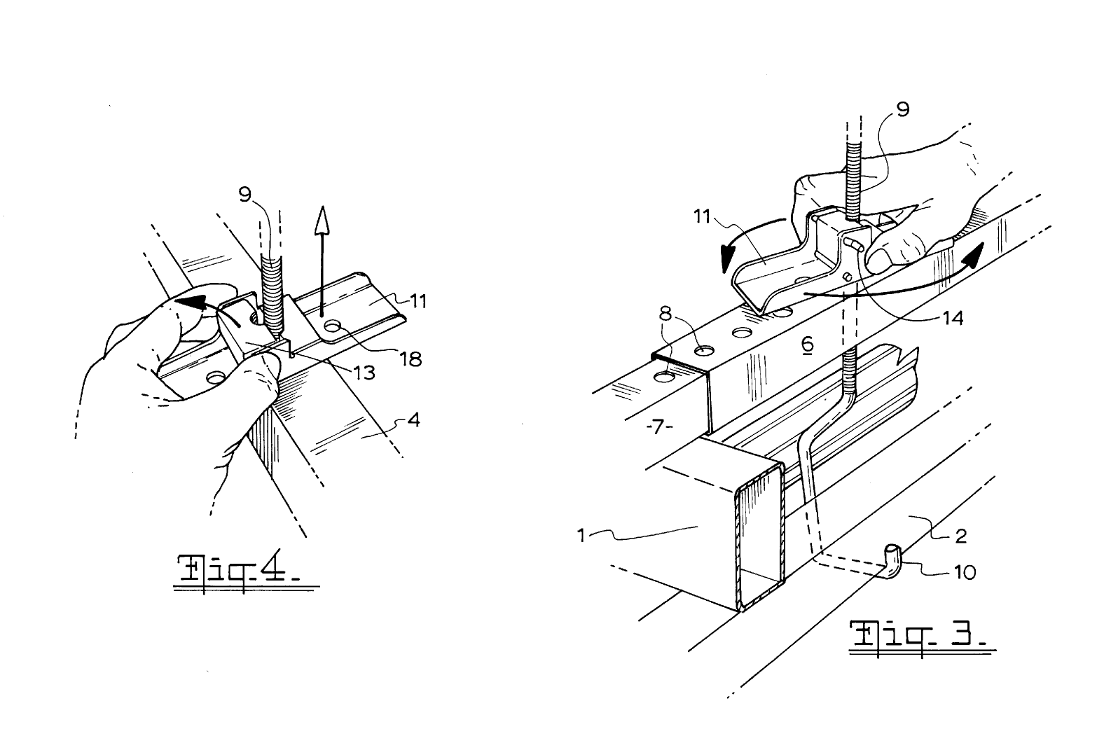

As shown in FIG. 3 both first and second members 6 and 7 have a number of evenly spaced holes 8 in line along the top and bottom sides of the members. When first member 6 receives second member 7 holes 8 can be aligned to provide a clean path through the whole cross beam 4.

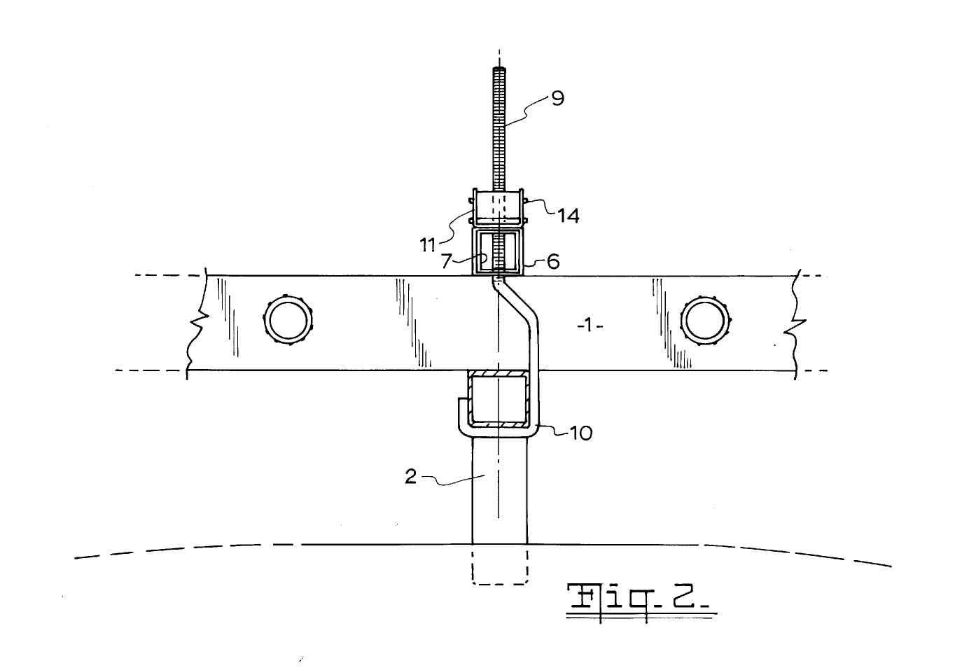

FIGS. 1, 2 and 3 show threaded shaft 9 of offset J-shaped hook 10 passing through holes 8 in both sides of first and second members 6 and 7 which prevents movement of the members relative to each other thereby fixing the length of cross beam 4. Hook 10 hooks under rack 2 while cross beam 4 rests on top of ladder 1 thereby sandwiching ladder 1 between roof rack 2 and cross beam 4. It will be obvious to one skilled in the art that hook 10 can be curved or square or any other suitable shape.

Hook shaft 9 is threaded and cross beam 4 is secured in place using handle 11 with a mating threaded hole (not shown). Handle 11 can be wound such that it follows the thread of hook shaft 9 downwards towards cross beam 4 and tightens cross beam 4 to rack 2 securing ladder 1 as shown in FIG. 3.

Handle 11 also has a number of evenly spaced holes 18 along its length that will align with holes 8 in the first and second members of cross beam 4. A long shackle padlock 12 can be inserted through the aligned holes 18 and 8 in handle 11 and first and second members 6 and 7 and locked to secure lock 3 in the fastened position shown in FIG. 1.

To remove ladder 1 it is necessary to unlock and remove padlock 12 first. Then handle 11 can be wound so that it follows the thread upwards until it reaches the top of hook shaft 9 and can be removed. However handle 11 also has a quick release mechanism whereby a portion 13 of handle 11 is hinged and can be moved away from the other part of handle 11 to disengage handle 11 from hook shaft 9 thereby releasing handle 11 and eliminating the need to wind handle 11 off.

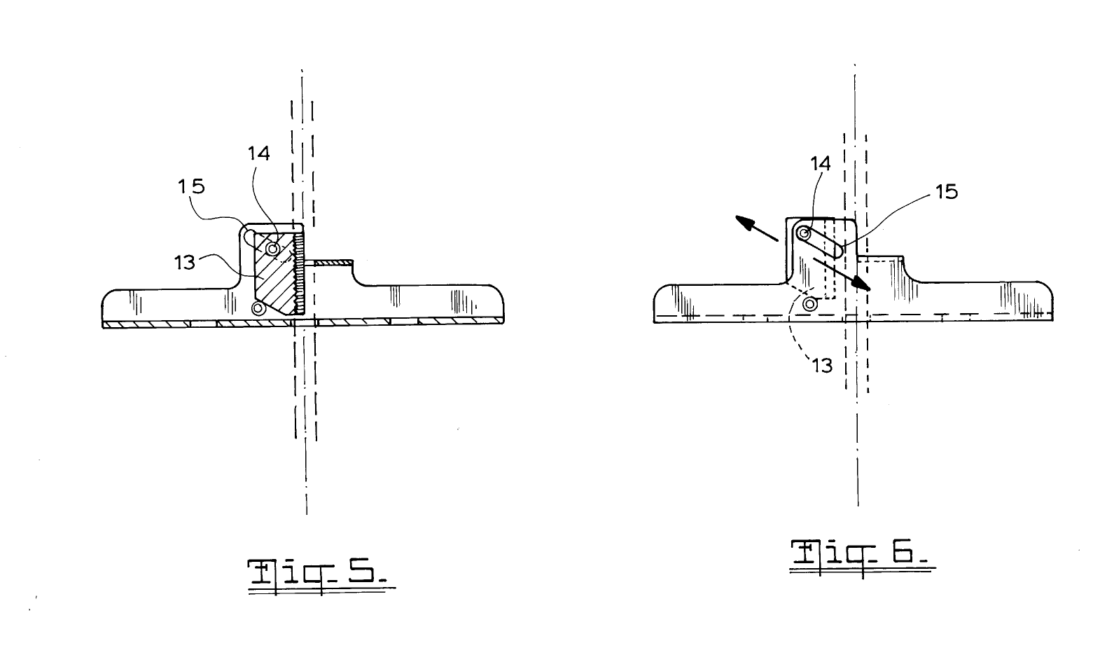

This quick release mechanism is achieved by small protrusions 14 on hinged portion 13 which extend outside handle 11 and can be grasped and pulled away from threaded hook shaft 9 as shown in FIG. 4. FIGS. 5 and 6 show hinged portion 13 moving along groove 15 so that it travels backward and upward to disengage the thread of hinged portion 13 from that of hook shaft 9. FIG. 5 shows hinged portion 13 in the engaged position and FIG. 6 shows hinged portion 13 in the released position.

### ADVANTAGES

The lock of the present invention is extendable and can be used with any size ladder or trestle which eliminates the need to have multiple sized locks suited to different ladders or trestles. The quick release mechanism further decreases the time involved with removing ladders or trestles from storage while the offset shaft of the hook improves the safety and function of the lock by preventing rotation of the lock during use and making it easier to hook under the rack.

### VARIATIONS

It will be realized that the foregoing has been given by way of illustrative example only and that all other modifications and variations as would be apparent to persons skilled in the art are deemed to fall within the broad scope and ambit of the invention as herein set forth.

Throughout the description and claims of this specification the words “comprise” and variations of that word such as “comprises” and “comprising” are not intended to exclude other additives components integers or steps.

What is claimed is:

1. A lock for fastening one or more ladders or trestles to a rack comprising a hook which hooks under the rack while the shaft of the hook extends through and beyond the one or more ladders or trestles and a cross beam with a flange at each end which receives the shaft of the hook and sits on and around the one or more ladders or trestles and a handle which also receives the shaft of the hook and secures the cross beam in place thereby fastening the one or more ladders or trestles to the rack and wherein said cross beam is extendable to fit a variety of ladder or trestle sizes.

2. The lock of claim 1 wherein the extendable cross beam has a first and second member, the first member being hollow with a flange at one end and the other end being open to receive the second member, the second member having a flange at its other end.

3. The lock of claim 2 wherein the first and second members of the extendable cross beam have a number of holes along two opposing sides which can be aligned such that the shaft of the hook can pass through the first and second members preventing movement of the members relative to each other thereby fixing the length of the cross beam.

4. The lock of claim 1 wherein the hook shaft is threaded and the handle has a mating threaded hole such that the handle can be wound to either secure or release the cross beam from the one or more ladders or trestles and wherein the handle has a quick release mechanism comprising a hinged portion which can be moved to disengage the thread of the handle and the hook shaft to allow the handle to be taken off without the need to wind the handle off.

5. The lock of claim 2 wherein the hook shaft is threaded and the handle has a mating threaded hole such that the handle can be wound to either secure or release the cross beam from the one or more ladders or trestles and wherein the handle has a quick release mechanism comprising a hinged portion which can be moved to disengage the thread of the handle and the hook shaft to allow the handle to be taken off without the need to wind the handle off.

6. The lock of claim 3 wherein the hook shaft is threaded and the handle has a mating threaded hole such that the handle can be wound to either secure or release the cross beam from the one or more ladders or trestles and wherein the handle has a quick release mechanism comprising a hinged portion which can be moved to disengage the thread of the handle and the hook shaft to allow the handle to be taken off without the need to wind the handle off.

7. The lock claim 1 wherein the shaft of the hook is offset.

8. The lock claim 2 wherein the shaft of the hook is offset.

9. The lock claim 3 wherein the shaft of the hook is offset.

10. The lock claim 4 wherein the shaft of the hook is offset.

11. The lock claim 5 wherein the shaft of the hook is offset.

12. The lock claim 6 wherein the shaft of the hook is offset.
